(19) United States
(12) Patent Application Publication
(10) Pub. No.: US 2025/0156459 A1
(43) Pub. Date: May 15, 2025

(54) TRAINING DATA IDENTIFICATION AND MODEL SELECTION

(71) Applicant: International Business Machines Corporation, Armonk, NY (US)

(72) Inventors: Anna Lisa Gentile, San Jose, CA (US); Daniel Gruhl, San Jose, CA (US); Shubhi Asthana, San Jose, CA (US); Chad Eric DeLuca, Morgan HIll, CA (US); Pawan Raghunath Chowdhary, San Jose, CA (US); Alfredo Alba, Morgan Hill, CA (US); Steven R. Welch, Gilroy, CA (US); Hirenkumar Ashokbhai Thummar, SANTA CLARA, CA (US); Linda Ha Kato, San Jose, CA (US); Bing Zhang, San Jose, CA (US)

(21) Appl. No.: 18/509,435

(22) Filed: Nov. 15, 2023

(51) Int. Cl. G06F 16/33; G06F 16/2457

(52) U.S. Cl. CPC G06F 16/3344; G06F 16/24578

(57) ABSTRACT

Techniques are provided for training data identification and model selection. In one embodiment, the techniques involve querying a first language learning model with a first query, wherein the first language learning model generates a text output response to the first query, generating groupings of the text output response, wherein the groupings include multiple n-grams, generating a source score of the groupings based on a first training data and a second training data, and identifying the first training data as training data of the first language learning model based on the source score.

### BACKGROUND

The present disclosure relates to language learning models (LLMs), and more specifically, to identifying training data used to train LLMs and selecting LLMs for use based on the identified training data.

Traditional LLMs are designed to understand and reproduce human language by analyzing training data to learn language-based patterns, semantics, and context cues. The LLMs can employ neural network architectures and deep learning techniques to process the training data, and establish correlative or causal relationships between input data and human language outputs. However, the LLMs generally do not reveal the data sets on which they were trained, thereby complicating efforts to identify potential issues associated with the training data.

### SUMMARY

A method is provided according to one embodiment of the present disclosure. The method includes querying a first language learning model with a first query, where the first language learning model generates a text output response to the first query; generating groupings of the text output response, where the groupings include multiple n-grams; generating a source score of the groupings based on a first training data and a second training data; and identifying the first training data as training data of the first language learning model based on the source score.

A system is provided according to one embodiment of the present disclosure. The system includes a processor; and memory or storage comprising an algorithm or computer instructions, which when executed by the processor, performs an operation that includes querying a first language learning model with a first query, where the first language learning model generates a text output response to the first query; generating groupings of the text output response, where the groupings include multiple n-grams; generating a source score of the groupings based on a first training data and a second training data; and identifying the first training data as training data of the first language learning model based on the source score.

A computer-readable storage medium having computer-readable program code embodied therewith, the computer-readable program code executable by one or more computer processors to perform an operation, is provided according to one embodiment of the present disclosure. The operation includes querying a first language learning model with a first query, where the first language learning model generates a text output response to the first query; generating groupings of the text output response, where the groupings include multiple n-grams; generating a source score of the groupings based on a first training data and a second training data; and identifying the first training data as training data of the first language learning model based on the source score.

A system is provided according to one embodiment of the present disclosure. The system includes a processor; and memory or storage comprising an algorithm or computer instructions, which when executed by the processor, performs an operation that includes identifying a first training data as training data of a first language learning model based on a source score; generating a ranking of training data based on queries and ratings of corresponding responses of a set of language learning models, where the ranking of training data includes a ranking of a first training data; selecting a second language learning model of the set of language learning models based on the ranking of training data and a query; and generating a response to the query based on the second language learning model.

A computer-readable storage medium having computer-readable program code embodied therewith, the computer-readable program code executable by one or more computer processors to perform an operation, is provided according to one embodiment of the present disclosure. The operation includes identifying a first training data as training data of a first language learning model based on a source score; generating a ranking of training data based on queries and ratings of corresponding responses of a set of language learning models, the ranking of training data includes a ranking of a first training data; selecting a second language learning model of the set of language learning models based on the ranking of training data and a query; and generating a response to the query based on the second language learning model.

### BRIEF DESCRIPTION OF THE DRAWINGS

FIG. 1 illustrates a computing environment, according to one embodiment.

FIG. 2 illustrates a training data identification and model selection environment, according to one embodiment.

FIG. 3 illustrates a flowchart of a method of determining that given training data was used to train a language learning model, according to one embodiment.

FIG. 4 illustrates a flowchart of a method of selecting and using a language learning model, according to one embodiment.

### DETAILED DESCRIPTION

A method is provided according to one embodiment of the present disclosure. The method includes querying a first language learning model with a first query, where the first language learning model generates a text output response to the first query; generating groupings of the text output response, where the groupings include multiple n-grams; generating a source score of the groupings based on a first training data and a second training data; and identifying the first training data as training data of the first language learning model based on the source score. Advantageously, this enables the identification of the training data of a language learning model, thereby enabling the identification of potential issues associated with training data (e.g., biases or potential infringement of intellectual property rights associated with the training data).

According to another embodiment of the present disclosure, the method further includes generating a ranking of training data based on queries and ratings of corresponding responses of a set of language learning models, where the ranking of training data includes a ranking of the first training data; selecting a second language learning model of the set of language learning models based on the ranking of training data and a second query; and generating a response to the second query based on the second language learning model. Advantageously, this enables the selection and use of a machine learning model catered to a user preference to respond to a query, which improves user experiences in engaging with responses the machine learning mode.

According to another embodiment of the present disclosure, the source score represents a likelihood that the first training data was used to train the first language learning model, and generating the source score involves generating a first score of the groupings based on the first training data, the first training data representing a potential source of the training data used by the first language learning model; and generating a second score of the groupings based on the second training data, the second training data representing standard communication data of a given population. Further, according to another embodiment, the source score is determined as Score_{S}=max(0, (Score₁−Score₂)), Score_{S} represents the source score, Score₁ represents the first score of the groupings, and Score₂ represents the second score of the groupings. Advantageously, this enables a comparison between a number of grouping appearances in the first training data and an expected number of appearances of the grouping in a baseline, second training data, thereby allowing for a determination of whether the groupings appear more in the first training data.

According to another embodiment of the present disclosure, the first score is determined as

$${Score}_{1} = \frac{\sum {log}_{10} \frac{( n - {grams}_{overlap} + 1 )}{( n - {grams}_{unique} )}}{{log}_{10} ( {firsttrainingdata}_{Bytes} )} ,$$

Score₁ represents the first score, n-gramsₒᵥₑᵣₗₐₚₛ represents a number of overlaps between each of the n-grams and the first training data, n-grams_{unique} represents a number of unique n-grams in the text output response, and the first training data _{Bytes} represents a size of the first training data in bytes. Advantageously, this enables a normalization of the number grouping appearances in the first training data to a determined scale, thereby enabling suitable comparisons between the number of grouping appearances in the first training data and the number of grouping appearances in a baseline, second training data.

According to another embodiment of the present disclosure, the second score is determined as

$${Score}_{2} = \frac{\sum {log}_{10} \frac{( n - {grams}_{overlap} + 1 )}{( n - {grams}_{unique} )}}{{log}_{10} ( {firsttrainingdata}_{Bytes} )} ,$$

Score₂ represents the second score, n-gramsₒᵥₑᵣₗₐₚₛ represents a number of overlaps between each of the n-grams and the second training data, n-grams_{unique} represents a number of unique n-grams in the text output response, and the second training data _{Bytes} represents a size of the second training data in bytes. Advantageously, this enables a normalization of the number grouping appearances in the baseline, second training data to the determined scale, thereby enabling suitable comparisons between the number of grouping appearances in the second training data and the number of grouping appearances in the first training data.

A system is provided according to one embodiment of the present disclosure. The system includes a processor; and memory or storage comprising an algorithm or computer instructions, which when executed by the processor, performs an operation that includes querying a first language learning model with a first query, where the first language learning model generates a text output response to the first query; generating groupings of the text output response, where the groupings include multiple n-grams; generating a source score of the groupings based on a first training data and a second training data; and identifying the first training data as training data of the first language learning model based on the source score. Advantageously, this enables the identification of the training data of a language learning model, thereby enabling the identification of potential issues associated with training data (e.g., biases or potential infringement of intellectual property rights associated with the training data).

According to another embodiment of the present disclosure, the operation further includes generating a ranking of training data based on queries and ratings of corresponding responses of a set of language learning models, where the ranking of training data includes a ranking of the first training data; selecting a second language learning model of the set of language learning models based on the ranking of training data and a second query; and generating a response to the second query based on the second language learning model. Advantageously, this enables the selection and use of a machine learning model catered to a user preference to respond to a query, which improves user experiences in engaging with responses the machine learning mode.

According to another embodiment of the present disclosure, the source score represents a likelihood that the first training data was used to train the first language learning model, and generating the source score involves generating a first score of the groupings based on the first training data, the first training data representing a potential source of the training data used by the first language learning model; and generating a second score of the groupings based on the second training data, the second training data representing standard communication data of a given population. Further, according to another embodiment, the source score is determined as Score_{S}=max(0, (Score₁−Score₂)), Score_{S} represents the source score, Score₁ represents the first score of the groupings, and Score₂ represents the second score of the groupings. Advantageously, this enables a comparison between a number of grouping appearances in the first training data and an expected number of appearances of the grouping in a baseline, second training data, thereby allowing for a determination of whether the groupings appear more in the first training data.

According to another embodiment of the present disclosure, the first score is determined as

$${Score}_{1} = \frac{\sum {log}_{10} \frac{( n - {grams}_{overlap} + 1 )}{( n - {grams}_{unique} )}}{{log}_{10} ( {firsttrainingdata}_{Bytes} )} ,$$

Score₁ represents the first score, n-gramsₒᵥₑᵣₗₐₚₛ represents a number of overlaps between each of the n-grams and the first training data, n-grams_{unique} represents a number of unique n-grams in the text output response, and the first training data _{Bytes} represents a size of the first training data in bytes. Advantageously, this enables a normalization of the number grouping appearances in the first training data to a determined scale, thereby enabling suitable comparisons between the number of grouping appearances in the first training data and the number of grouping appearances in a baseline, second training data.

According to another embodiment of the present disclosure, the second score is determined as

$${Score}_{2} = \frac{\sum {log}_{2} \frac{( n - {grams}_{overlaps} + 1 )}{( n - {grams}_{unique} )}}{{log}_{10} ( {secondtrainingdata}_{Bytes} )} ,$$

Score₂ represents the second score, n-gramsₒᵥₑᵣₗₐₚₛ represents a number of overlaps between each of the n-grams and the second training data, n-grams_{unique} represents a number of unique n-grams in the text output response, and the second training data _{Bytes} represents a size of the second training data in bytes. Advantageously, this enables a normalization of the number grouping appearances in the baseline, second training data to the determined scale, thereby enabling suitable comparisons between the number of grouping appearances in the second training data and the number of grouping appearances in the first training data.

A computer-readable storage medium having computer-readable program code embodied therewith, the computer-readable program code executable by one or more computer processors to perform an operation, is provided according to one embodiment of the present disclosure. The operation includes querying a first language learning model with a first query, where the first language learning model generates a text output response to the first query; generating groupings of the text output response, where the groupings include multiple n-grams; generating a source score of the groupings based on a first training data and a second training data; and identifying the first training data as training data of the first language learning model based on the source score. Advantageously, this enables the identification of the training data of a language learning model, thereby enabling the identification of potential issues associated with training data (e.g., biases or potential infringement of intellectual property rights associated with the training data).

According to another embodiment of the present disclosure, the operation further includes generating a ranking of training data based on queries and ratings of corresponding responses of a set of language learning models, where the ranking of training data includes a ranking of the first training data; selecting a second language learning model of the set of language learning models based on the ranking of training data and a second query; and generating a response to the second query based on the second language learning model. Advantageously, this enables the selection and use of a machine learning model catered to a user preference to respond to a query, which improves user experiences in engaging with responses the machine learning mode.

According to another embodiment of the present disclosure, the source score represents a likelihood that the first training data was used to train the first language learning model, and generating the source score involves generating a first score of the groupings based on the first training data, the first training data representing a potential source of the training data used by the first language learning model; and generating a second score of the groupings based on the second training data, the second training data representing standard communication data of a given population. Further, according to another embodiment, the source score is determined as Score_{S}=max(0, (Score₁−Score₂)), Score_{S} represents the source score, Score₁ represents the first score of the groupings, and Score₂ represents the second score of the groupings. Advantageously, this enables a comparison between a number of grouping appearances in the first training data and an expected number of appearances of the grouping in a baseline, second training data, thereby allowing for a determination of whether the groupings appear more in the first training data.

According to another embodiment of the present disclosure, the first score is determined as

$${Score}_{1} = \frac{\sum {log}_{10} \frac{( n - {grams}_{overlaps} + 1 )}{( n - {grams}_{unique} )}}{{log}_{10} ( {firsttrainingdata}_{Bytes} )} ,$$

Score₁ represents the first score, n-gramsₒᵥₑᵣₗₐₚₛ represents a number of overlaps between each of the n-grams and the first training data, n-grams_{unique} represents a number of unique n-grams in the text output response, and the first training data _{Bytes} represents a size of the first training data in bytes. Advantageously, this enables a normalization of the number grouping appearances in the first training data to a determined scale, thereby enabling suitable comparisons between the number of grouping appearances in the first training data and the number of grouping appearances in a baseline, second training data.

According to another embodiment of the present disclosure, the second score is determined as

$${Score}_{2} = \frac{\sum {log}_{10} \frac{( n - {grams}_{overlaps} + 1 )}{( n - {grams}_{unique} )}}{{log}_{10} ( {secondtrainingdata}_{Bytes} )} ,$$

Score₂ represents the second score, n-gramsₒᵥₑᵣₗₐₚₛ represents a number of overlaps between each of the n-grams and the second training data, n-grams_{unique} represents a number of unique n-grams in the text output response, and the second training data _{Bytes} represents a size of the second training data in bytes. Advantageously, this enables a normalization of the number grouping appearances in the baseline, second training data to the determined scale, thereby enabling suitable comparisons between the number of grouping appearances in the second training data and the number of grouping appearances in the first training data.

A system is provided according to one embodiment of the present disclosure. The system includes a processor; and memory or storage comprising an algorithm or computer instructions, which when executed by the processor, performs an operation that includes identifying a first training data as training data of a first language learning model based on a source score; generating a ranking of training data based on queries and ratings of corresponding responses of a set of language learning models, where the ranking of training data includes a ranking of a first training data; selecting a second language learning model of the set of language learning models based on the ranking of training data and a query; and generating a response to the query based on the second language learning model. Advantageously, this enables the selection and use of a machine learning model catered to a user preference to respond to a query, which improves user experiences in engaging with responses the machine learning mode.

According to another embodiment of the present disclosure, the operation further comprises querying the first language learning model with a first query, where the first language learning model generates a text output response to the first query; generating groupings of the text output response, where the groupings include multiple n-grams; and generating the source score of the groupings based on a first training data and a second training data. Advantageously, this enables the identification of the training data of a language learning model, thereby enabling the identification of potential issues associated with training data (e.g., biases or potential infringement of intellectual property rights associated with the training data).

According to another embodiment of the present disclosure, the source score represents a likelihood that the first training data was used to train the first language learning model, and generating the source score involves generating a first score of the groupings based on the first training data, the first training data representing a potential source of the training data used by the first language learning model; and generating a second score of the groupings based on the second training data, the second training data representing standard communication data of a given population. Further, according to another embodiment, the source score is determined as Score_{S}=max(0, (Score₁−Score₂)), Score_{S} represents the source score, Score₁ represents the first score of the groupings, and Score₂ represents the second score of the groupings; the first score is determined as

$${Score}_{1} = \frac{\sum {log}_{10} \frac{( n - {grams}_{overlaps} + 1 )}{( n - {grams}_{unique} )}}{{log}_{10} ( {firsttrainingdata}_{Bytes} )} ,$$

Score₁ represents the first score, n-gramsₒᵥₑᵣₗₐₚₛ represents a number of overlaps between each of the n-grams and the first training data, n-grams_{unique} represents a number of unique n-grams in the text output response, and the first training data _{Bytes} represents a size of the first training data in bytes; and the second score is determined as

$${Score}_{2} = \frac{\sum {log}_{10} \frac{( n - {grams}_{overlaps} + 1 )}{( n - {grams}_{unique} )}}{{log}_{10} ( {secondtrainingdata}_{Bytes} )} ,$$

Score₂ represents the second score, n-gramsₒᵥₑᵣₗₐₚₛ represents a number of overlaps between each of the n-grams and the second training data, n-grams_{unique} represents a number of unique n-grams in the text output response, and the second training data _{Bytes} represents a size of the second training data in bytes. Advantageously, this enables a comparison between a number of grouping appearances in the first training data and an expected number of appearances of the grouping in a baseline, second training data, thereby allowing for a determination of whether the groupings appear more in the first training data. Further, this enables a normalization of the number grouping appearances in the first training data to a determined scale, thereby enabling suitable comparisons between the number of grouping appearances in the first training data and the number of grouping appearances in a baseline, second training data.

A computer-readable storage medium having computer-readable program code embodied therewith, the computer-readable program code executable by one or more computer processors to perform an operation, is provided according to one embodiment of the present disclosure. The operation includes identifying a first training data as training data of a first language learning model based on a source score; generating a ranking of training data based on queries and ratings of corresponding responses of a set of language learning models, the ranking of training data includes a ranking of a first training data; selecting a second language learning model of the set of language learning models based on the ranking of training data and a query; and generating a response to the query based on the second language learning model. Advantageously, this enables the selection and use of a machine learning model catered to a user preference to respond to a query, which improves user experiences in engaging with responses the machine learning mode.

According to another embodiment of the present disclosure, the operation further comprises querying the first language learning model with a first query, the first language learning model generates a text output response to the first query; generating groupings of the text output response, the groupings include multiple n-grams; and generating the source score of the groupings based on a first training data and a second training data. Advantageously, this enables the identification of the training data of a language learning model, thereby enabling the identification of potential issues associated with training data (e.g., biases or potential infringement of intellectual property rights associated with the training data).

According to another embodiment of the present disclosure, the source score represents a likelihood that the first training data was used to train the first language learning model, and generating the source score involves generating a first score of the groupings based on the first training data, the first training data representing a potential source of the training data used by the first language learning model; and generating a second score of the groupings based on the second training data, the second training data representing standard communication data of a given population. Advantageously, this enables a comparison between a number of grouping appearances in the first training data and an expected number of appearances of the grouping in a baseline, second training data, thereby allowing for a determination of whether the groupings appear more in the first training data.

Embodiments of the present disclosure improve upon training data identification techniques by providing a training data identification and model selection (TDIMS) module that determines a likelihood that given training data was used to train a language learning model. In one embodiment, the TDIMS module queries an LLM using a query designed to elicit a long-form response. The TDIMS module can then generate scores of n-grams of the response, and use the scores to determine which training data was used to train the LLM. The TDIMS module can also rank the determined training data based on subject matter, user ratings, and user demographics. The TDMIS module can then use the ranking to select an LLM that generates an optimal response to a query.

One benefit of the disclosed embodiments is to identify potential issues associated with training data (e.g., biases or potential infringement of intellectual property rights associated with the training data). Further, embodiments of the present disclosure can improve user experiences with language learning models by selecting and using models trained on data catered to user preferences.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

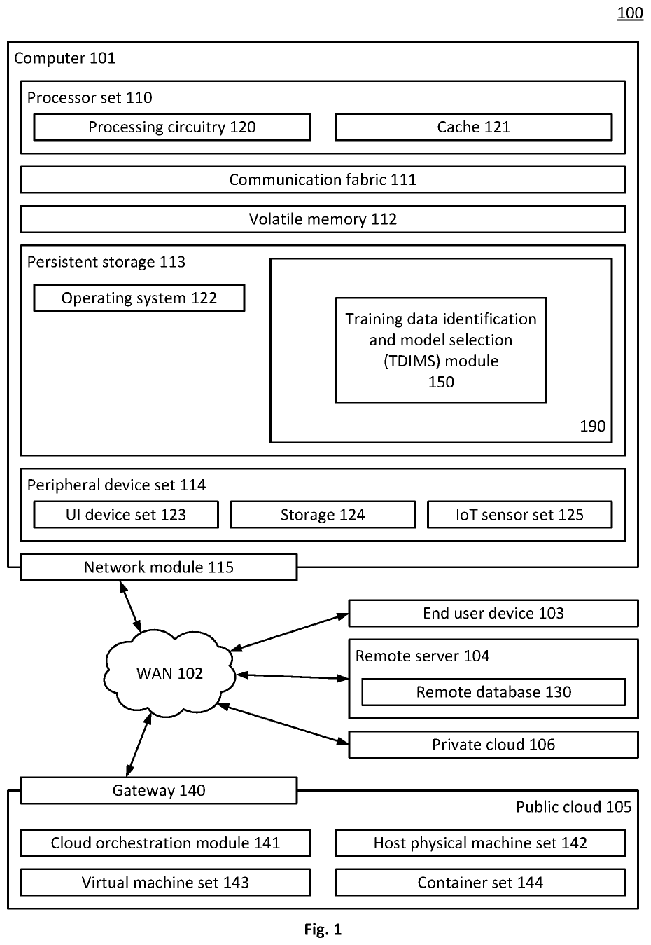

FIG. 1 illustrates a computing environment 100, according to one embodiment. Computing environment 100 contains an example of an environment for the execution of at least some of the computer code involved in performing the inventive methods, such as a new training data identification and model selection (TDIMS) module 150, shown in block 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

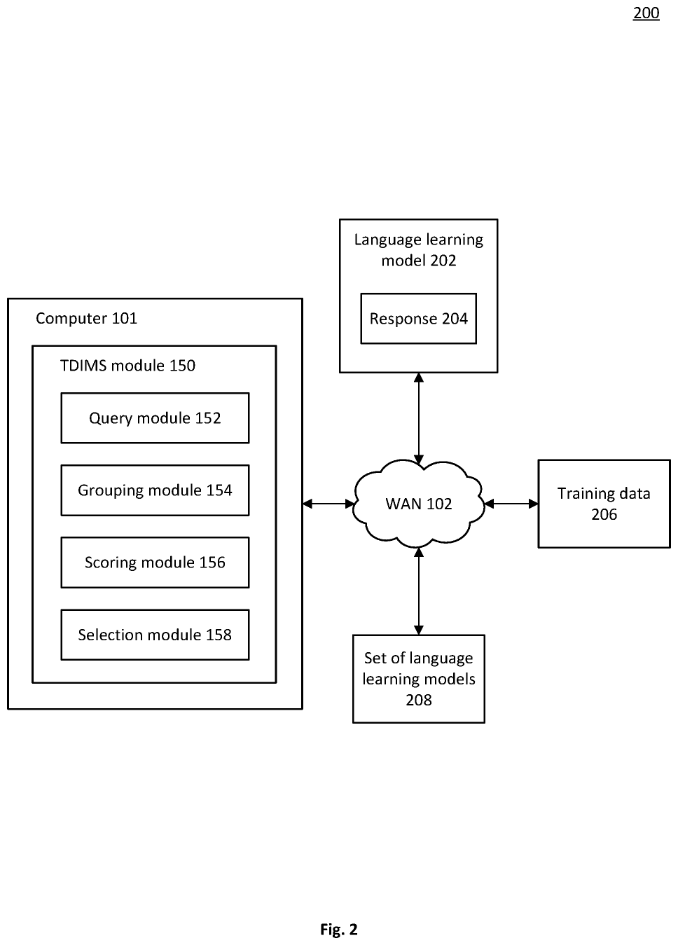

FIG. 2 illustrates a training data identification and model selection (TDIMS) environment 200, according to one embodiment. In the illustrated embodiment, the TDIMS environment 200 includes the computer 101, a language learning model 202, training data 206, and a set of language learning models 208. Features of the TDIMS environment 200 are communicatively coupled via the WAN 102.

As shown, the computer 101 can include the TDIMS module 150, which further includes a query module 152, a grouping module 154, a scoring module 156, and a selection module 158. In one embodiment, the TDIMS module 150, and the modules included therein, represent one or more algorithms, instruction sets, software applications, or other computer-readable program code that can be executed by the processor set 110 of the computer 101 to perform the functions, operations, or processes described herein.

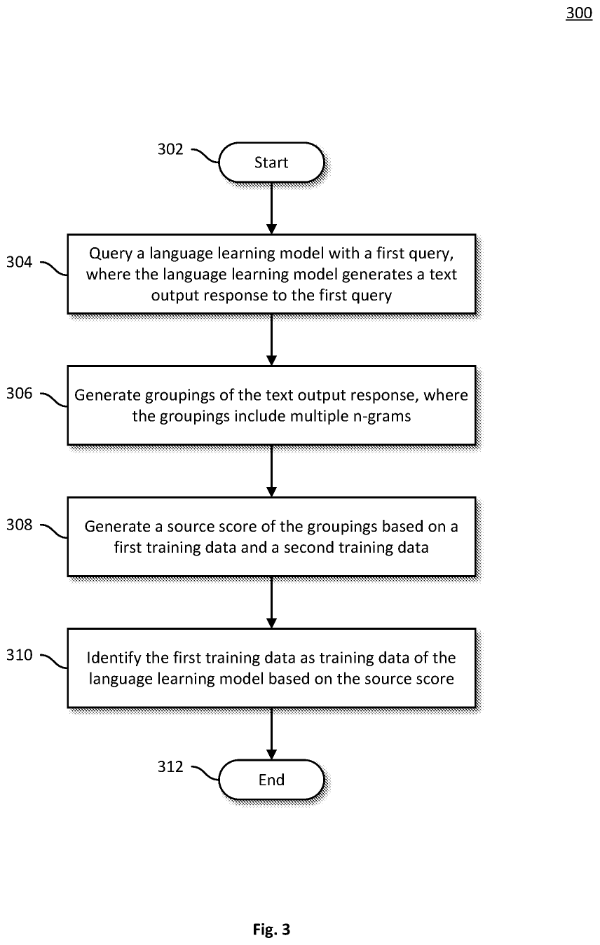

In one embodiment, the query module 152 interrogates the language learning model (LLM) 202 using a predetermined query designed to elicit a long-form response 204 from the LLM 202. The grouping module 154 can make n-grams of the response 204. Afterwards, the scoring module 156 can generate scores of the n-grams that indicate the likelihood that the n-grams are found within various training data. The TDIMS module 150 can then use the scores to determine whether given training data (e.g., training data 206) was used to train the LLM 202. These processes are discussed further in FIG. 3 below.

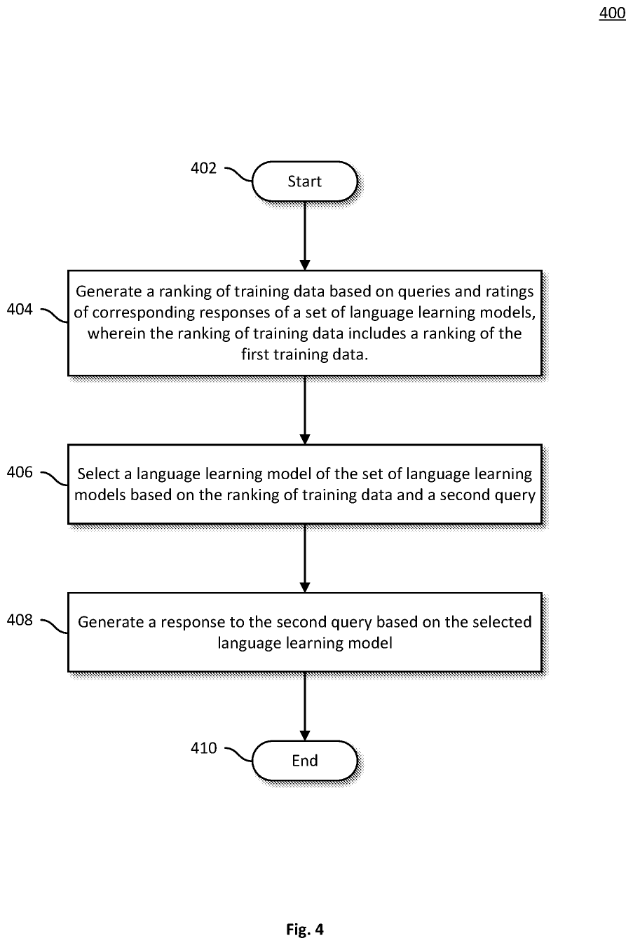

After identifying the training data 206 used to train the LLM 202, the selection module 158 can rank the training data 206 based on user ratings of the response 204 and the first query. This process can be repeated for different LLMs and corresponding queries and responses to generate a set of ranked training data. Afterwards, the selection module 158 can select an LLM (from the set of LLMs 208) that was trained on training data with the highest ranking to respond to a user query that is similar to the query used to generate the response 204. These processes are discussed further in FIG. 4 below.

FIG. 3 illustrates a flowchart of a method 300 of determining that given training data was used to train a language learning model, according to one embodiment. In one embodiment, the method 300 is performed by the training data identification and model selection (TDIMS) module 150.

As previously discussed, the TDIMS module 150 can include a query module 152, a grouping module 154, a scoring module 156, and a selection module 158. The method 300 begins at block 302.

At block 304, the query module 152 queries a language learning model 202 with a first query, where the language learning model 202 generates a text output response to the first query. In one embodiment, the query module 152 queries the language learning model (LLM) 202 using one of multiple predetermined queries designed to elicit a long-form response 204 from the LLM 202. A long-form response 204 can include an explanation directed toward the query, as opposed to a single-word or binary response.

For example, the query module can input a prompt to the LLM 202 that states, “What is an electron?” The response 204 of the LLM 202 may be, “An electron is a subatomic particle that carries a negative electric charge.”

At block 306, the grouping module 154 generates groupings of the text output response, where the groupings include multiple n-grams. In one embodiment, an n-gram is a continuous sequence of text elements (amounting to “n” text elements), such as words, characters, punctuation, spaces, or the like. For instance, a 3-gram can include 3 text elements (“An electron is”), while a 4-gram can include 4 text elements (“An electron is a”).

In one embodiment, grouping module 154 generates overlapping, unique 5-grams of the response 204 of the LLM 202. One benefit to using 5-grams is to capture identifiers of a source of an expression, as empirical evidence suggests that 5 consecutive words of a text is sufficient to express idiosyncrasies that can be used as the identifiers.

The grouping module 154 can generate a number n-grams of the response 204 that collectively cover all words of the response 204. Continuing the previous example, the grouping module 154 may generate the 8 following 5-grams: 1. “An electron is a subatomic;” 2. “electron is a subatomic particle,” 3. “is a subatomic particle that,” 4. “a subatomic particle that carries,” 5. “subatomic particle that carries a,” 6. “particle that carries a negative,” 7. “that carries a negative electric,” and 8. “carries a negative electric charge.”

At block 308, the scoring module 156 generates a source score of the groupings based on a first training data and a second training data. In one embodiment, the source score represents a likelihood that the first training data was used to train the language learning model 202.

The first training data can represent a potential source of the training data used by the language learning model. The first training data can be, for instance, a corpus such as an online database, a patent database, a code repository, a book, a web-based text reference, or the like.

The second training data can represent standard or common communication data of a given population. For instance, the second training data may be a corpus such as a collection of text data crawled from websites in a given country, covering a wide range of topics and domains. The second training data may provide representative samples of language use in the country as reflected on the web, such that an evaluation of the groupings appearing in the first training data can be compared to a baseline, expected number of appearances of the groupings in the second training data.

In one embodiment, the source score is determined as follows: Score_{S}=max(0, (Score₁−Score₂)), where Score_{S} represents the source score, Score₁ represents a first score of the groupings relative to the first training data, and Score₂ represents a second score of the groupings relative to a second training data.

The first score may be generated as follows:

$${Score}_{1} = \frac{\sum {log}_{10} \frac{( n - {grams}_{overlaps} + 1 )}{( n - {grams}_{unique} )}}{{log}_{10} ( {firsttrainingdata}_{Bytes} )} ,$$

where Score₁ represents the first score of the groupings, n-gramsₒᵥₑᵣₗₐₚₛ represents the number of overlaps between each of the n-grams and the first training data, n-grams_{unique} represents the number of unique n-grams in the response 204, and the first training data _{Bytes} represents the size of the first training data in bytes.

Continuing the previous example, assuming that the response 204 includes further explanation of an electron for academics, the grouping module 154 may generate 20,000 unique 5-grams of the response 204. Assuming all the text elements of a given 5-gram appear in the first training data 5000 times, there would be 5000 n-gramsₒᵥₑᵣₗₐₚₛ. Therefore, log₁₀(5000+1)/20000 would represent a first element of the summation. A similar summation is performed for the n-gramsₒᵥₑᵣₗₐₚₛ of each of the unique 5-grams. Assuming the first training data 100 GB, the total summation is then divided by log₁₀(1 e11 bytes).

The second score may be generated as follows:

$${Score}_{2} = \frac{\sum {log}_{10} \frac{( n - {grams}_{overlaps} + 1 )}{( n - {grams}_{unique} )}}{{log}_{10} ( {secondtrainingdata}_{Bytes} )} ,$$

where Score₂ represents the second score of the groupings, n-gramsₒᵥₑᵣₗₐₚₛ represents the number of overlaps between each of the n-grams and the second training data, n-grams_{unique} represents the number of unique n-grams in the response 204, and the second training data _{Bytes} represents the size of the second training data in bytes.

At block 310, the TDIMS module 150 identifies the first training data as training data of the language learning model 202 based on the source score. In one embodiment, a larger source score indicates a greater likelihood that the first training data was used to train the language learning model 202. Therefore, the training data with the largest source score is identified as primary training data of the language learning model 202. The method 300 ends at block 312.

FIG. 4 illustrates a flowchart of a method 400 of selecting and using a language learning model, according to one embodiment. In one embodiment, the method 400 is performed by the training data identification and model selection (TDIMS) module 150.

As previously discussed, the TDIMS module 150 can include a query module 152, a grouping module 154, a scoring module 156, and a selection module 158. The method 400 begins at block 402.

At block 404, the selection module 158 generates a ranking of training data based on queries and ratings of corresponding responses of a set of language learning models 208. In one embodiment, the selection module 158 classifies the queries according to the subject matter of the queries. The selection module 158 can retrieve the ratings of responses from a database that includes user ratings collected from surveys of the responses. In one embodiment, the ranking of training data includes a classification of the subject matter of the first query and a ranking of the first training data.

The user ratings may also include user demographics that can provide context for the ratings. For instance, an academic user may give higher ratings to responses that reflect data and jargon from academic journals.

At block 406, the selection module 158 selects a language learning model of the set of language learning models 208 based on the ranking of training data and a second query. In one embodiment, the selection module 158 can use a natural language processing engine to extract features from the second query, and use the features to determine a subject matter of the second query.

The selection module 158 can also use the features to determine a user demographic of a user that generated the second query. For instance, the selection module 158 can consider the selection of words of the second query to determine an age of the user, or the subject matter of the second query to determine a profession of the user, or the like.

In one embodiment, the selection module 158 filters the LLMs of the set of LLMs 208 based on matches between the subject matter of the second query and subject matter classifications in the ranking of training data. The selection module 158 may further filter the LLMs based on matches the user demographics of the user that generated the second query and the user demographics of the ranking of training data. Afterwards, the selection module 158 can select an LLM of the filtered LLMs was trained using the highest ranked training data (which may be determined via processes similar to the processes discussed in FIG. 3 above).

At block 408, the selection module 158 generates a response to the second query based on the selected language learning model. In this manner, the TDIMS module 150 can provide an optimized response to the second query, as determined by preferences of users with similar user demographics. The method 400 ends at block 412.

While the foregoing is directed to embodiments of the present invention, other and further embodiments of the invention may be devised without departing from the basic scope thereof, and the scope thereof is determined by the claims that follow.

What is claimed is:

1. A method comprising:
querying a first language learning model with a first query, wherein the first language learning model generates a text output response to the first query;
generating groupings of the text output response, wherein the groupings include multiple n-grams;
generating a source score of the groupings based on a first training data and a second training data; and
identifying the first training data as training data of the first language learning model based on the source score.

2. The method of claim 1, further comprising:
generating a ranking of training data based on queries and ratings of corresponding responses of a set of language learning models, wherein the ranking of training data includes a ranking of the first training data;
selecting a second language learning model of the set of language learning models based on the ranking of training data and a second query; and
generating a response to the second query based on the second language learning model.

3. The method of claim 1, wherein the source score represents a likelihood that the first training data was used to train the first language learning model, and wherein generating the source score involves:
generating a first score of the groupings based on the first training data, wherein the first training data represents a potential source of the training data used by the first language learning model; and
generating a second score of the groupings based on the second training data, wherein the second training data represents standard communication data of a given population.

4. The method of claim 3, wherein the source score is determined as Score_{S}=max(0, (Score₁−Score₂)), wherein Score_{S} represents the source score, wherein Score₁ represents the first score of the groupings, and wherein Score₂ represents the second score of the groupings.

5. The method of claim 4, wherein the first score is determined as
$${Score}_{1} = \frac{\sum {log}_{10} \frac{( n - {grams}_{overlaps} + 1 )}{( n - {grams}_{unique} )}}{{log}_{10} ( {firsttrainingdata}_{Bytes} )} ,$$
wherein Score₁ represents the first score, wherein n-gramsₒᵥₑᵣₗₐₚₛ represents a number of overlaps between each of the n-grams and the first training data, wherein n-grams_{unique} represents a number of unique n-grams in the text output response, and wherein the first training data _{Bytes} represents a size of the first training data in bytes.

6. The method of claim 4, wherein the second score is determined as
$${Score}_{2} = \frac{\sum {log}_{10} \frac{( n - {grams}_{overlaps} + 1 )}{( n - {grams}_{unique} )}}{{log}_{10} ( {secondtrainingdata}_{Bytes} )} ,$$
wherein Score₂ represents the second score, wherein n-gramsₒᵥₑᵣₗₐₚₛ represents a number of overlaps between each of the n-grams and the second training data, wherein n-grams_{unique} represents a number of unique n-grams in the text output response, and wherein the second training data _{Bytes} represents a size of the second training data in bytes.

7. A system, comprising:
a processor; and
memory or storage comprising an algorithm or computer instructions, which when executed by the processor, performs an operation comprising:
querying a first language learning model with a first query, wherein the first language learning model generates a text output response to the first query;
generating groupings of the text output response, wherein the groupings include multiple n-grams;
generating a source score of the groupings based on a first training data and a second training data; and
identifying the first training data as training data of the first language learning model based on the source score.

8. The system of claim 7, the operation further comprising:
generating a ranking of training data based on queries and ratings of corresponding responses of a set of language learning models, wherein the ranking of training data includes a ranking of the first training data;
selecting a second language learning model of the set of language learning models based on the ranking of training data and a second query; and
generating a response to the second query based on the second language learning model.

9. The system of claim 7, wherein the source score represents a likelihood that the first training data was used to train the first language learning model, and wherein generating the source score involves:
generating a first score of the groupings based on the first training data, wherein the first training data represents a potential source of the training data used by the first language learning model; and
generating a second score of the groupings based on the second training data, wherein the second training data represents standard communication data of a given population.

10. The system of claim 9, wherein the source score is determined as Score_{S}=max(0, (Score₁−Score₂)), wherein Score_{S} represents the source score, wherein Score₁ represents the first score of the groupings, and wherein Score₂ represents the second score of the groupings.

11. The system of claim 10, wherein the first score is determined as
$${Score}_{1} = \frac{\sum {log}_{10} \frac{( n - {grams}_{overlaps} + 1 )}{( n - {grams}_{unique} )}}{{log}_{10} ( {firsttrainingdata}_{Bytes} )} ,$$
wherein Score₁ represents the first score, wherein n-gramsₒᵥₑᵣₗₐₚₛ represents a number of overlaps between each of the n-grams and the first training data, wherein n-grams_{unique} represents a number of unique n-grams in the text output response, and wherein the first training data _{Bytes} represents a size of the first training data in bytes.

12. The system of claim 10, wherein the second score is determined as
$${Score}_{2} = \frac{\sum {log}_{10} \frac{( n - {grams}_{overlaps} + 1 )}{( n - {grams}_{unique} )}}{{log}_{10} ( {secondtrainingdata}_{Bytes} )} ,$$
wherein Score₂ represents the second score, wherein n-gramsₒᵥₑᵣₗₐₚₛ represents a number of overlaps between each of the n-grams and the second training data, wherein n-grams_{unique} represents a number of unique n-grams in the text output response, and wherein the second training data _{Bytes} represents a size of the second training data in bytes.

13. A computer-readable storage medium having a computer-readable program code embodied therewith, the computer-readable program code executable by one or more computer processors to perform an operation comprising:
querying a first language learning model with a first query, wherein the first language learning model generates a text output response to the first query;
generating groupings of the text output response, wherein the groupings include multiple n-grams;
generating a source score of the groupings based on a first training data and a second training data; and
identifying the first training data as training data of the first language learning model based on the source score.

14. The computer-readable storage medium of claim 13, the operation further comprising:
generating a ranking of training data based on queries and ratings of corresponding responses of a set of language learning models, wherein the ranking of training data includes a ranking of the first training data;
selecting a second language learning model of the set of language learning models based on the ranking of training data and a second query; and
generating a response to the second query based on the second language learning model.

15. The computer-readable storage medium of claim 13, wherein the source score represents a likelihood that the first training data was used to train the first language learning model, and wherein generating the source score involves:
generating a first score of the groupings based on the first training data, wherein the first training data represents a potential source of the training data used by the first language learning model; and
generating a second score of the groupings based on the second training data, wherein the second training data represents standard communication data of a given population.

16. The computer-readable storage medium of claim 15, wherein the source score is determined as Score_{S}=max(0, (Score₁−Score₂)), wherein Score_{S} represents the source score, wherein Score₁ represents the first score of the groupings, and wherein Score₂ represents the second score of the groupings.

17. The computer-readable storage medium of claim 16, wherein the first score is determined as
$${Score}_{1} = \frac{\sum {log}_{10} \frac{( n - {grams}_{overlaps} + 1 )}{( n - {grams}_{unique} )}}{{log}_{10} ( {firsttrainingdata}_{Bytes} )} ,$$
wherein Score₁ represents the first score, wherein n-gramsₒᵥₑᵣₗₐₚₛ represents a number of overlaps between each of the n-grams and the first training data, wherein n-grams_{unique} represents a number of unique n-grams in the text output response, and wherein the first training data _{Bytes} represents a size of the first training data in bytes.

18. The computer-readable storage medium of claim 16, wherein the second score is determined as
$${Score}_{2} = \frac{\sum {log}_{10} \frac{( n - {grams}_{overlaps} + 1 )}{( n - {grams}_{unique} )}}{{log}_{10} ( {secondtrainingdata}_{Bytes} )} ,$$
wherein Score₂ represents the second score, wherein n-gramsₒᵥₑᵣₗₐₚₛ represents a number of overlaps between each of the n-grams and the second training data, wherein n-grams_{unique} represents a number of unique n-grams in the text output response, and wherein the second training data _{Bytes} represents a size of the second training data in bytes.

19. A system, comprising:
a processor; and
memory or storage comprising an algorithm or computer instructions, which when executed by the processor, performs an operation comprising:
identifying a first training data as training data of a first language learning model based on a source score;
generating a ranking of training data based on queries and ratings of corresponding responses of a set of language learning models, wherein the ranking of training data includes a ranking of a first training data;
selecting a second language learning model of the set of language learning models based on the ranking of training data and a query; and
generating a response to the query based on the second language learning model.

20. The system of claim 19, the operation further comprising:
querying the first language learning model with a first query, wherein the first language learning model generates a text output response to the first query;
generating groupings of the text output response, wherein the groupings include multiple n-grams; and
generating the source score of the groupings based on a first training data and a second training data.

21. The system of claim 20, wherein the source score represents a likelihood that the first training data was used to train the first language learning model, and wherein generating the source score involves:
generating a first score of the groupings based on the first training data, wherein the first training data represents a potential source of the training data used by the first language learning model; and
generating a second score of the groupings based on the second training data, wherein the second training data represents standard communication data of a given population.

22. The system of claim 21, wherein the source score is determined as Score_{S}=max(0, (Score₁−Score₂)), wherein Score_{S} represents the source score, wherein Score₁ represents the first score of the groupings, and wherein Score₂ represents the second score of the groupings;
wherein the first score is determined as
$${Score}_{1} = \frac{\sum {log}_{10} \frac{( n - {grams}_{overlaps} + 1 )}{( n - {grams}_{unique} )}}{{log}_{10} ( {firsttrainingdata}_{Bytes} )} ,$$
wherein Score₁ represents the first score, wherein n-gramsₒᵥₑᵣₗₐₚₛ represents a number of overlaps between each of the n-grams and the first training data, wherein n-grams_{unique} represents a number of unique n-grams in the text output response, and wherein the first training data _{Bytes} represents a size of the first training data in bytes; and
wherein the second score is determined as
$${Score}_{2} = \frac{\sum {log}_{10} \frac{( n - {grams}_{overlaps} + 1 )}{( n - {grams}_{unique} )}}{{log}_{10} ( {secondtrainingdata}_{Bytes} )} ,$$
wherein Score₂ represents the second score, wherein n-gramsₒᵥₑᵣₗₐₚₛ represents a number of overlaps between each of the n-grams and the second training data, wherein n-grams_{unique} represents a number of unique n-grams in the text output response, and wherein the second training data _{Bytes} represents a size of the second training data in bytes.

23. A computer-readable storage medium having a computer-readable program code embodied therewith, the computer-readable program code executable by one or more computer processors to perform an operation comprising:
identifying a first training data as training data of a first language learning model based on a source score;
generating a ranking of training data based on queries and ratings of corresponding responses of a set of language learning models, wherein the ranking of training data includes a ranking of a first training data;
selecting a second language learning model of the set of language learning models based on the ranking of training data and a query; and
generating a response to the query based on the second language learning model.

24. The computer-readable storage medium of claim 23, the operation further comprising:
querying the first language learning model with a first query, wherein the first language learning model generates a text output response to the first query;
generating groupings of the text output response, wherein the groupings include multiple n-grams; and
generating the source score of the groupings based on a first training data and a second training data.

25. The computer-readable storage medium of claim 24, wherein the source score represents a likelihood that the first training data was used to train the first language learning model, and wherein generating the source score involves:
generating a first score of the groupings based on the first training data, wherein the first training data represents a potential source of the training data used by the first language learning model; and
generating a second score of the groupings based on the second training data, wherein the second training data represents standard communication data of a given population.
